(19) United States
(12) Patent Application Publication
(10) Pub. No.: US 2025/0133632 A1
(43) Pub. Date: Apr. 24, 2025

(54) Battery-Powered Heater Device

(71) Applicant: Louisa Archer, Springfield Gardens, NY (US)

(72) Inventor: Louisa Archer, Springfield Gardens, NY (US)

(21) Appl. No.: 18/489,270

(22) Filed: Oct. 18, 2023

(51) Int. Cl. H05B 1/02; F24D 15/02; F24D 18/00; H05B 3/14

(52) U.S. Cl. CPC H05B 1/0275; F24D 15/02; F24D 18/00; H05B 3/141

(57) ABSTRACT

The present invention relates generally to the field of heaters. More specifically, the present invention relates to a battery-powered heater device. The device is primarily comprised of a housing, further comprised of a heating element, temperature display, and a temperature sensor. The housing is further comprised of a voice assistant, microphone, and at least one speaker. The device is also comprised of a battery pack, further comprised of a fireproof casing, a male connection port, and a female charging port. The male connection port connects to the female receiving port located on the housing. The device is further comprised of a remote. The remote may be comprised of a smart voice assistant. The device provides a user with a way to heat spaces without the need to access electrical power through wall outlets. The device provides a way for a user to control a portable heater with voice activated commands.

### FIELD OF THE INVENTION

The present invention relates generally to the field of heaters. More specifically, the present invention relates to a battery-powered heater device. The device is primarily comprised of a housing, further comprised of a heating element, temperature display, and a temperature sensor. The housing is further comprised of a motor and a base allowing the device to rotate around the base 360 degrees. The device is comprised of a removable and rechargeable battery that powers the heating element. The device is further comprised of a remote that allows the device to be operated remotely. The remote may be comprised of a smart voice assistant which provides the user with a way to operate the device via speaking into the remote. The device provides a user with a way to heat spaces without the need to access electrical power through wall outlets. The device further provides a novel way for a user to control a portable heater with voice activated commands. Accordingly, the present disclosure makes specific reference thereto. Nonetheless, it is to be appreciated that aspects of the present invention are also equally applicable to other like applications, devices and methods of manufacture.

### BACKGROUND

Heaters are used by many individuals to heat rooms or other spaces. However, existing heaters require constant electrical power to function. If there is no electrical power available, such as in the event of a power outage, then existing heaters known in the art cannot function. This can create dangerous situations when individuals are in cold climates in need of a heat source. Further, when individuals are camping, in a power outage, or in a broken-down car, they lack the ability to plug heaters into an electrical power source. Portable heat would benefit many individuals and provide them with ways to heat areas that lack sufficient electrical power sources.

Therefore, there exists a long-felt need in the art for an improved heater. There also exists a long-felt need in the art for a battery-powered heater device that does not require a constant electrical power source to function. Further, there exists a long-felt need in the art for a battery-powered heater device that has a plurality of useful functions and features. There also exists a long-felt need in the art for a battery-powered heater device that is portable and can be used to heat a plurality of spaces, regardless of electrical power capabilities. There further exists a long-felt need in the art for a battery-powered heater that has a rechargeable battery that further prevents against battery fires. Further, there exists a long-felt need in the art for a battery-powered heater device that does not need manual operation of the device. There also exists a long-felt need in the art for a battery-powered heater that can be controlled via speech through a smart voice assistant.

The subject matter disclosed and claimed herein, in one embodiment thereof, comprises a ceramic battery-powered heater device. The device is primarily comprised of a housing, a heating element, and a motor that rotates the housing 360 degrees around the base. The device is comprised of a battery that powers the device which eliminates the need for constant electrical power. Further, the battery is comprised of a casing that prevents against battery fires. The device is also comprised of a smart voice assistant that allows users to operate the device through voice commands, eliminating the need to manually operate the device. Further, the device is comprised of a remote that can also be used to operate the device.

In this manner, the ceramic battery-powered heater device of the present invention accomplishes all of the foregoing objectives and provides a novel battery-powered heater device that allows a user to heat an area without an electrical power source. Further, the device prevents battery fires because of the fireproof battery pack casing, as well as allows a user to operate the device remotely through voice activation.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a ceramic battery-powered heater device. The device is preferably comprised of a housing, a battery pack, and a remote. The housing may be comprised of a motor and a base to allow the housing to rotate 360 degrees around the base. The housing is also comprised of a heating element that is preferably a ceramic heating element. In addition, the device is comprised of a smart voice assistant that allows a user to control the device via speech. The user's speech is picked up by a microphone in the housing such that commands from the device are played back through at least one speaker located on the device. The housing is also comprised of a temperature display that displays the temperature inside and outside of the room the device is placed in. The housing also has a temperature sensor that shuts off the device when the room reaches a set temperature. This allows the battery life to be saved and prevents the room from getting too hot.

The device is also comprised of a battery pack. The battery pack is further comprised of a battery which supplies power to the device. The battery pack is preferably comprised of a fireproof casing that can help prevent against battery fires. The battery pack is further comprised of a male connection port which connects to the reciprocating female receiving port. Through the connection of the male connection port and the female receiving port, the battery pack supplies power to the device. The battery pack is further charged by the charging cord. The charging cord plugs into any wall outlet and then the male charging port plugs into the female charging port on the battery pack. This charges the battery pack for further use.

The device is also comprised of a remote that can control the device. The remote is further comprised of a plurality of heating level buttons. The buttons allow for the heating level of the device to be changed to fit the needs of the user. The remote further may be comprised of a smart voice assistant that can allow a user to speak into the remote to control the device. The remote has at least one microphone in order to hear the commands from the user, as well as t at least one speaker to relay commands to the user. The remote further has a temperature display that shows the user the temperature inside the room and outside the room.

Accordingly, the ceramic battery-powered heater device of the present invention is particularly advantageous as it provides a user with a way to heat spaces without the need to access electrical power through wall outlets. Further, the device provides users with a means for portable heat no matter the area. The device further provides a novel way for a user to control a portable heater with voice-activated commands. In this manner, the ceramic battery-powered heater device overcomes the limitations of existing heaters known in the art.

Numerous benefits and advantages of this device will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a ceramic battery-powered heater device of the present invention in accordance with the disclosed architecture;

FIG. 2 illustrates an enhanced view of a battery pack of one potential embodiment of a ceramic battery-powered heater device of the present invention in accordance with the disclosed architecture; and

FIG. 3 illustrates a perspective view of one potential embodiment of a remote of one potential embodiment of a ceramic battery-powered heater device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved heater. There also exists a long-felt need in the art for a battery-powered heater device that does not require a constant electrical power source to function. Further, there exists a long-felt need in the art for a battery-powered heater device that has a plurality of useful functions and features. There also exists a long-felt need in the art for a battery-powered heater device that is portable and can be used to heat a plurality of spaces, regardless of electrical power capabilities. There further exists a long-felt need in the art for a battery-powered heater that has a rechargeable battery that further prevents against battery fires. Further, there exists a long-felt need in the art for a battery-powered heater device that does not need manual operation of the device. There also exists a long-felt need in the art for a battery-powered heater that can be controlled via speech through a smart voice assistant.

The present invention, in one exemplary embodiment, is comprised of a ceramic battery-powered heater device. The device is preferably comprised of a housing that may further be comprised of a battery pack and a remote. The housing may be comprised of any material, and is comprised of a motor and a base to allow the housing to rotate 360 degrees around the base. The housing is also comprised of a temperature display that displays the temperature inside and outside of the room the device is placed in. The housing also has a temperature sensor that shuts off the device when the room reaches a set temperature. This allows the battery life to be saved and prevents the room from getting too hot. The housing is further comprised of a heating element that is preferably a ceramic heating element. The housing further is comprised of a smart voice assistant that allows a user to control the device via speech. The housing is comprised of a microphone that receives the speech and a speaker that can relay commands to the user to further assist in the use of the device.

The device is also comprised of a battery pack. The battery pack provides the power to operate the device. The battery pack is preferably comprised of a fireproof casing that can help prevent against battery fires. The battery pack is further comprised of a male connection port which connects to the reciprocating female receiving port. The male connection port provides power to the device through the female receiving port. The battery pack is further charged by the charging cord. The charging cord plugs into any wall outlet and then the male charging port plugs into the female charging port on the battery pack. This charges the battery pack for further use.

The device is also comprised of a remote that can control the device. The remote is further comprised of a plurality of heating level buttons. The buttons allow for the heating level of the device to be changed to fit the needs of the user. The remote further may be comprised of a smart voice assist that can allow a user to speak into the remote to control the device. The remote has at least one microphone in order to hear the commands from the user, as well as the remote is comprised of at least one speaker to relay commands to the user. The remote further has a temperature display that shows the user the temperature inside the room and outside the room.

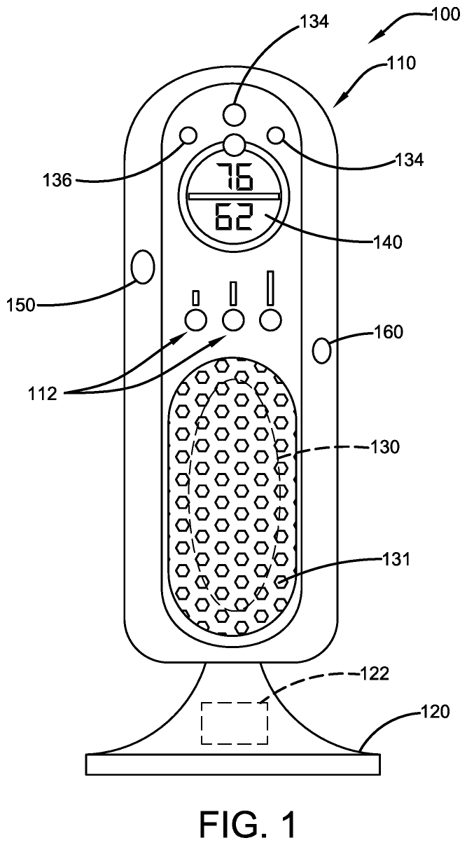

Referring initially to the drawings, FIG. 1 illustrates a perspective view of one potential embodiment of a ceramic battery-powered heater device 100 of the present invention in accordance with the disclosed architecture. The device 100 is primarily comprised of at least one housing 110 further comprised of a base 120, at least one motor 122, at least one heating element 130, at least one speaker 132, at least one microphone 134, a voice assistant 136, at least one temperature display 140, at least one temperature sensor 150, and at least one receiving port 114.

The housing 110 may be manufactured from any housing material known in the art, but in the preferred embodiment, the housing 110 is made from a plastic material. There are a plurality of plastic materials that may be used such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. Further, the housing 110 may be manufactured in any shape known in the art such as, but not limited to: circular, rectangular, ovular, etc.

The housing 110 is comprised of a base 120. In one embodiment, a motor 122 may allow the housing 110 to rotate 360 degrees around the base 120. This allows the device 100 to heat the entirety of the space in all directions. The motor 122 may be any motor known in the art. In another embodiment, the housing 110 is fixed to the base 120. The base 120 may be manufactured in any shape known in the art.

The housing 110 is comprised of at least one power button 160 to turn the device 100 off and on. The housing 110 is further comprised of at least one heating level button 112. The heating level buttons 112 allow for the user to choose the desired heating level of the device 100. In the preferred embodiment, there are three heating level buttons 112 wherein one button is for a low heating setting, one is for a medium heat setting, and the third is for a high heat setting. In one embodiment, the heating level buttons 112 protrude from the housing 110 surface. In another embodiment, the heating level buttons 112 may be located on the temperature display 140 screen and have touch screen capabilities.

The housing 110 is comprised of at least one integrated temperature display 140. In the preferred embodiment, the temperature display 140 can display the indoor and outdoor temperatures of the space/room that the device 100 is placed in. Further, the temperature display 140 has touch screen capabilities. The temperature display 140 may be any display screen known in the art such as, but not limited to: LCD, LED, OLED, Plasma, CRT, micro-LED, etc.

The housing 110 is comprised of at least one temperature sensor 150. The temperature sensor 150 automatically shuts the device 100 off when the temperature in the space/room reaches the set designated temperature to be achieved by the device 100. This ensures that the power in the battery pack 124 lasts to its full capacity.

The housing 110 is also comprised of at least one smart voice assistant 136. The voice assistant 136 allows a user to control the functions of the device 100 via speech. The speech is further heard by at least one microphone 134 located on the housing 110. The microphone 134 relays the speech to the voice assistant 136 via electrical communication. The microphone 134 may be any microphone known in the art. Further, the housing 110 is comprised of at least one speaker 132. The speaker 132 relays voice commands to the user. The speaker 132 may be any speaker known in the art. The voice assistant 136 may also be found in the remote 200.

The device 100 is also comprised of at least one heating element 130 located inside the housing 110 of the device 100. The heating element 130 may be any heating element known in the art, but it is preferably a ceramic heating element 130. There are a plurality of ceramic heating elements 130 that may be used, such as but not limited to, sheet heating elements, needle heating elements, ring ceramic heating elements, PTC ceramic heating elements, trough elements, hollow elements, flat elements, etc. The heating element 130 further is shielded by at least one grate 131. The grate 131 may be any grate known in the art of heat-resistant material that protects a user from being burned by the heating element 130.

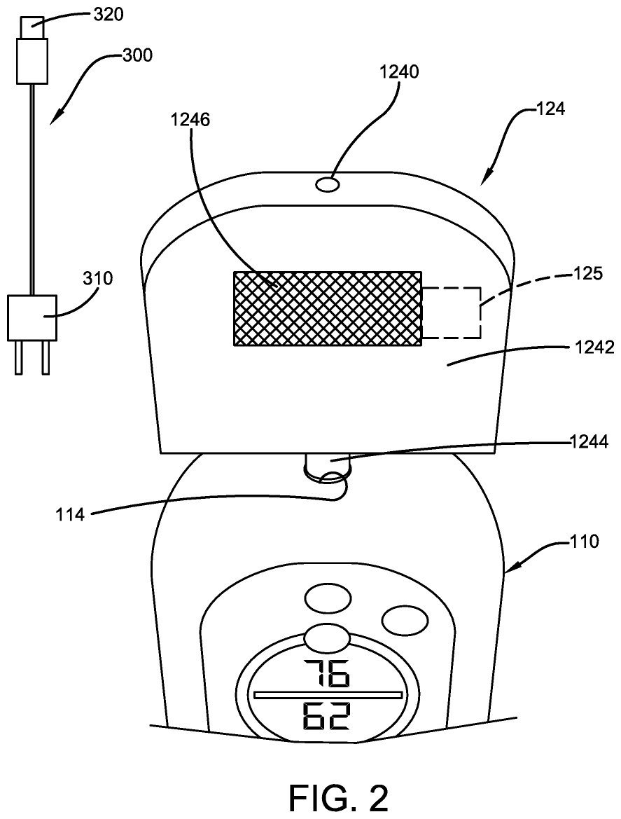

FIG. 2 illustrates an enhanced view of a battery pack 124 of one potential embodiment of a ceramic battery-powered heater device 100 of the present invention in accordance with the disclosed architecture. The device 100 is comprised of at least one battery pack 124 comprised of a casing 1242, a charging port 1240, a male connection port 1244, a grip area 1246, and at least one battery 125.

The battery pack 124 is comprised of at least one battery 125. The battery 125 may be in the form of an alkaline, nickel-cadmium, nickel-metal hydride battery, etc., such as any 3V-12-volt DC battery 125 or other conventional battery 125 that supplies power to the battery pack 124. Throughout this specification the terms “battery” and “batteries” may be used interchangeably to refer to one or more wet or dry cells, or batteries 125 of cells, in which chemical energy is converted into electricity and used as a source of DC power. References to recharging or replacing batteries 124 may refer to recharging or replacing individual cells, individual batteries 124 of cells, or a package of multiple battery cells as is appropriate for any given battery 124 technology that may be used.

The battery pack 124 may be comprised of a male connection port 1244. The male connection port 1244 connects to the female receiving port 114 located on the housing 110 of the device 100 such that the battery pack 124 is detachable from the housing 110. This allows a plurality of charged packs 124 to be used with the housing 110. The male connection port 1244 supplies the power from the battery pack 124 to the device 100 through the female receiving port 114. The male connection port 1244 and the reciprocating female receiving port 114 may be any connection port known in the art such as, but not limited to: USB port, non-polar IEC C8, polar IEC C8, NEMA 1-15P, IEC C6, IEC C7, IEC C16, DC+5V, optical plug, XLR, RCA, TRS, DVI, thunderbolt, ST connector, etc.

The battery pack 124 is comprised of a casing 1242. The casing 1242 may be any casing known in the art, but it is preferably a fireproof casing. In the preferred embodiment, the casing 1242 is fireproof in order to lower the risk of a battery fire starting while the device 100 is in use. This allows a user to leave the device 100 unattended and not have to worry about the risk of a fire. The casing 1242 material may be any fireproof material known in the art such as, but not limited to: polyimide, polybenzimidazole, polybenzoxazole, polybenzimidazole, UL94 V-2, ULD4 V-1. UL94 HB, UL94 V-0, fiberglass, cellulose, mineral wool, OSB panel, etc.

In the preferred embodiment, the casing 1242 is further comprised of at least one grip area 1246 that allows a user to grab onto the battery pack 124 more securely. The grip area 1246 may be any texture or contoured area known in the art to allow a user to have better control of the battery pack 124. In the preferred embodiment, the grip area 1246 is manufactured from a textured rubber that allows a user to hold onto the battery pack 124. There is a plurality of rubbers that may be used such as, but not limited to: natural rubbers, neoprene rubber elastomer, silicone rubber elastomer, ethylene propylene diene monomer rubber, butyl rubber, nitrile rubber, buna-n rubber, styrene-butadiene rubber elastomers, viton rubber elastomer, diaphragm rubber, thermoplastic rubber, etc.

The device 100 is also comprised of at least one charging cord 300. The charging cord 300 is further comprised of a plug 310 and a male charging port 320. The plug 310 plugs into a wall outlet and supplies power to the battery pack 124 through the male charging port 320. The plug 310 may be any plug that is compatible with a wall outlet such, as but not limited to, 110 volt or 220 volt. The charging cord 300 further is comprised of a male charging port 320 that connects to the female charging port 1240 located on the battery pack 124. In the preferred embodiment, the male charging port 320 located on the charging cord 300 and the female charging port 1240 located on the battery pack 124 are connected via USB charging ports. The USB port can be any USB port, such as, but not limited to, micro-USB, USB B, USB C, or any other suitable charging port that is known in the art.

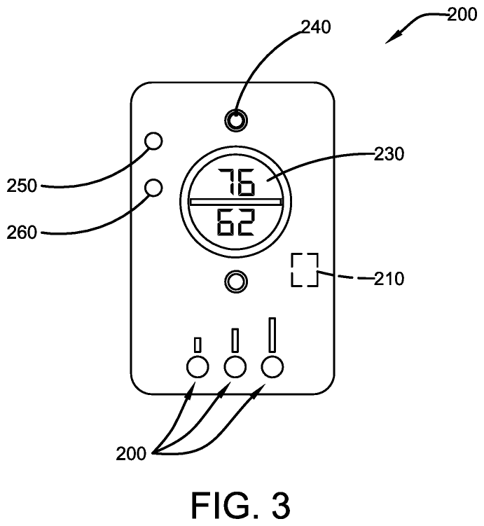

FIG. 3 illustrates a perspective view of one potential embodiment of a remote 200 of one potential embodiment of a ceramic battery-powered heater device 100 of the present invention in accordance with the disclosed architecture. In the preferred embodiment, the device 100 is comprised of at least one remote 200 that can further control the device 100. The remote 200 is powered by a at least one battery 210. The battery 210 may be in the form of an alkaline, nickel-cadmium, nickel-metal hydride battery, etc., such as any 3V-12-volt DC battery 210 or other conventional battery 210 that supplies power to the remote 200. Throughout this specification the terms “battery” and “batteries” may be used interchangeably to refer to one or more wet or dry cells, or batteries 210 of cells, in which chemical energy is converted into electricity and used as a source of DC power. References to recharging or replacing batteries 210 may refer to recharging or replacing individual cells, individual batteries 210 of cells, or a package of multiple battery cells as is appropriate for any given battery 210 technology that may be used.

The remote 200 may be comprised of at least one, but preferably a plurality of heating level buttons 220 that can change the level at which the device 100 emits heat. This allows the user to remotely control the levels of heat produced by the heating element 130. These heating level buttons 220 may either be protruding from the remote 200 or flush with the remote 200 for touch screen use on the temperature display 230. Further, the remote 200 is comprised of a temperature display 320 that shows the user what the temperature inside the room is as well as the outside of the room. This allows the user to be able to decide the level in which the device 100 should be set. The remote 200 is further comprised of a power button 240 that allows a user to turn the device 100 on and off.

The remote 200 may also be comprised of a voice assistant 136 that is in electrical communication with the voice assistant 136 of the housing. The voice assistant 136 provides a user with a way to control the device 100 by speaking into the remote 200. When a user speaks a command into the remote 200, the speech is heard by a microphone 250. Further, the remote 200 is comprised of at least one speaker 260 that projects voice responses to the user in order to allow for more convenient control of the device 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ceramic battery-powered heater device” and “device” are interchangeable and refer to the ceramic battery-powered heater device 100 of the present invention.

Notwithstanding the foregoing, the ceramic battery-powered heater device 100 of the present invention and its various components can be of any suitable size and configuration as is known in the art without affecting the overall concept of the invention, provided that they accomplish the above-stated objectives. One of ordinary skill in the art will appreciate that the size, configuration and material of the ceramic battery-powered heater device 100 as shown in the FIGS. are for illustrative purposes only, and that many other sizes and shapes of the ceramic battery-powered heater device 100 are well within the scope of the present disclosure. Although the dimensions of the ceramic battery-powered heater device 100 are important design parameters for user convenience, the ceramic battery-powered heater device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ceramic battery-powered heater device comprising:
a base;
a housing attached to the base;
a motor;
a battery;
a heating element; and
a temperature display.

2. The ceramic battery-powered heater device of claim 1, wherein the motor rotates the housing around the base.

3. The ceramic battery-powered heater device of claim 1, wherein the heating element is comprised of a ceramic heating element.

4. The ceramic battery-powered heater device of claim 3, wherein the heating element is comprised of a low heat setting, a medium heat setting, and a high heat setting.

5. The ceramic battery-powered heater device of claim 1, wherein the temperature display is comprised of a touchscreen display.

6. A ceramic battery-powered heater device comprising:
a base;
a housing attached to the base;
a motor;
a battery;
a heating element;
a temperature display; and
a remote.

7. The ceramic battery-powered heater device of claim 6, wherein the temperature display displays a temperature from a temperature sensor.

8. The ceramic battery-powered heater device of claim 7, wherein the heating element shuts off when a first temperature is detected by the temperature sensor.

9. A ceramic battery-powered heater device comprising:
a base;
a housing attached to the base;
a motor;
a battery;
a speaker;
a first microphone;
a second microphone;
a heating element;
a voice assistant;
a temperature display; and
a remote.

10. The ceramic battery-powered heater device of claim 9, wherein the first microphone is positioned on the housing.

11. The ceramic battery-powered heater device of claim 9, wherein the second microphone is positioned on the remote.

12. The ceramic battery-powered heater device of claim 9, wherein the voice assistant controls a function of the ceramic battery-powered heater device.

13. The ceramic battery-powered heater device of claim 12, wherein the voice assistant can be engaged by speaking to the first microphone or the second microphone.

14. The ceramic battery-powered heater device of claim 9, wherein the battery is positioned within a battery pack.

15. The ceramic battery-powered heater device of claim 9, wherein the battery pack is comprised of a male connection port.

16. The ceramic battery-powered heater device of claim 15, wherein the male connection port engages a female connection port of the housing.

17. The ceramic battery-powered heater device of claim 14, wherein the battery pack is comprised of a fireproof casing.

18. The ceramic battery-powered heater device of claim 9 further comprised of a charging cord.

19. The ceramic battery-powered heater device of claim 18, wherein the charging cord can charge the battery.

20. The ceramic battery-powered heater device of claim 9, wherein the remote controls at least one function of the ceramic battery-powered heater device.
